(19) United States
(12) Patent Application Publication
(10) Pub. No.: US 2003/0156351 A1
(43) Pub. Date: Aug. 21, 2003

(54) Multiple filter for use in a disc drive

(76) Inventors: Ronald Lyle Voights, Burnsville, MN (US); Quock Ying Ng, Singapore (SG)

Correspondence Address: David C. Bohn, WESTMAN CHAMPLIN & KELLY, Suite 1600 - International Centre, 900 South Second Avenue, Minneapolis, MN, 55402-3319, US

(21) Appl. No.: 10/179,913

(22) Filed: Jun. 25, 2002

Related U.S. Application Data
(60) Provisional application No. 60/359,278, filed on Feb. 20, 2002.

(51) Int. Cl. G11B 17/02

(52) U.S. Cl. 360/97.02

(57) ABSTRACT

A layer of air adjacent a disc surface in a disc drive is subject to contamination by particles. The disc is spun, inducing a radial air flow and a recirculation air flow. A particle impact layer around an outer disc edge traps a first portion of the particles carried by the radial air flow. A filter adjacent the outer disc edge includes a recirculation filter element that traps a second portion of the particles carried by the recirculation air flow.

### CROSS-REFERENCE TO RELATED APPLICATION

This application claims priority benefits from U.S. Provisional Application 60/359,278 titled “Shroud Filter for Disc Drive.” filed Feb. 20, 2002.

### FIELD OF THE INVENTION

The present invention relates generally to methods and components for reducing airborne particles inside data storage disc drives. In particular, the present invention relates to arrangements for filtering particles that can cause loss of data or damage to the disc drive.

### BACKGROUND OF THE INVENTION

Particulates on a surface of a disc in a disc drive can interfere with the operation of a read/write head flying over the disc surface. As the disc spins, air flow tends to move particulates so that a particle passes between a read/write head and a disc, resulting in loss of data or damage. The particles in the disc drive's enclosure that come between the head and disc can cause performance problems such as media defects, thermal asperities, stiction, or catastrophic drive failure.

Various types of filters are known to filter out particles, such as impaction filters and integrated filters.

In spite of use of a variety of different kinds of filters, there is still a need to improve filtering performance and thereby reduce incidence of lost data or mechanical damage due to particles as the density of data storage increases and the dimensions of components and tolerance for particles decreases. More complete particle removal is needed and there is a need to trap smaller size particles that were not as great a problem with lower density drives.

### SUMMARY OF THE INVENTION

Disclosed is a disc drive that includes a disc having a disc surface that extends from a central hub to an outer disc edge. The disc is spun about a central axis. A layer of air is adjacent the disc surface and is subject to contamination by particles. The spinning of the disc surface induces a radial air flow and a recirculation air flow.

A shroud is spaced apart from the outer disc edge and faces the radial air flow. A particle impact layer is disposed on the shroud. The particle impact layer is formed of a material that traps a first portion of the particles carried by the radial air flow.

A filter is also disposed adjacent the outer disc edge. The filter comprises a recirculation filter element that traps a second portion of the particles carried by the recirculation air flow.

These and various other features as well as advantages that characterize the present invention will be apparent upon reading of the following detailed description and review of the associated drawings.

### BRIEF DESCRIPTION OF THE DRAWINGS

FIG. 1 illustrates a PRIOR ART disc drive storage device.

FIG. 2 schematically illustrates an embodiment of a disc storage drive that includes a particle impact layer and a recirculation filter element.

FIG. 3 schematically illustrates a path of a particle near a spinning disc.

FIG. 4 schematically illustrates a cross sectional view of layers of air adjacent disc surfaces that include a radial component of air flow passing over a particle impact layer.

FIG. 5 schematically illustrates an oblique view of an embodiment of a particle impact layer.

FIG. 6 schematically illustrates an embodiment of a filter that includes a recirculation filter element.

FIG. 7 schematically illustrates an embodiment of a disc storage drive that includes a chemical filter backing interposed between a shroud and a particle impact layer.

### DETAILED DESCRIPTION OF ILLUSTRATIVE EMBODIMENTS

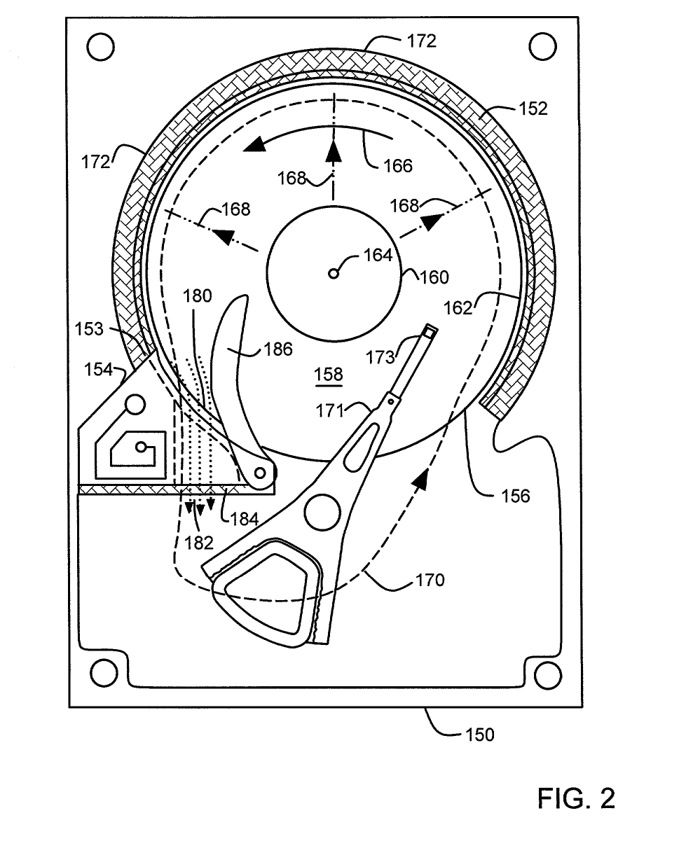

In the embodiments described below in FIGS. 2, 4-7, a disc drive has improved filtering performance. Lost data and/or mechanical damage due to particles in higher density disc drives is reduced. The disc drive includes a particle impact layer spaced apart from an outer disc edge, facing a radial air flow from a spinning disc in the disc drive. The particle impact layer is formed of a material that traps a first portion of the particles that is carried by the radial air flow. A filter is also disposed adjacent the outer disc edge. The filter comprises a recirculation filter element that traps a second portion of the particles that is carried by a recirculation air flow from the spinning disc.

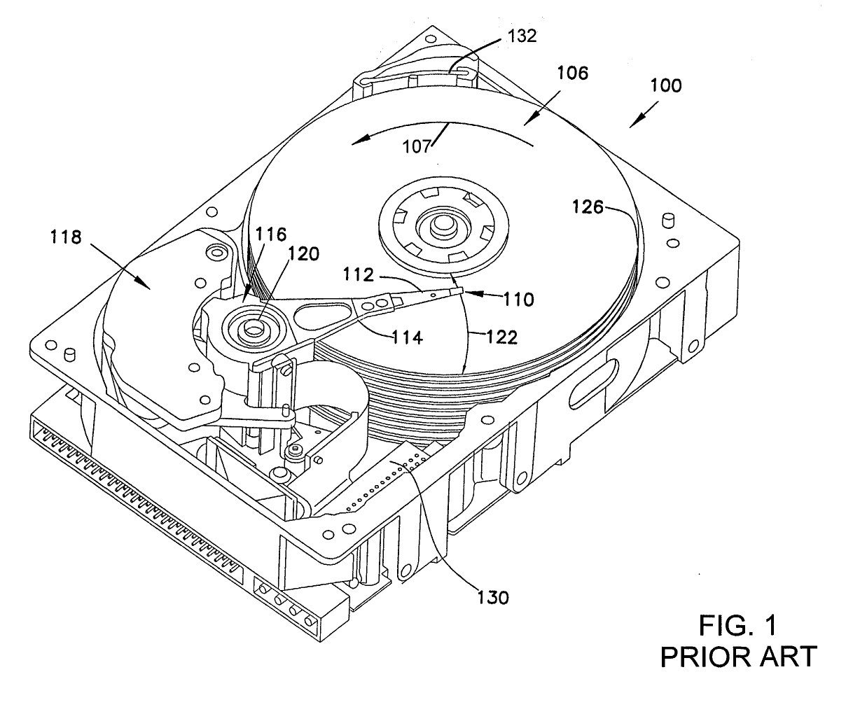

FIG. 1 illustrates a PRIOR ART embodiment of a disc drive storage device 100. Disc drive 100 includes a disc pack 126 having storage surfaces 106 that are illustratively layers of material (such as magnetic material or optically readable material). The disc pack 126 includes a stack of multiple discs each accessible by a read/write assembly 112 that includes a slider 110 that includes a read/write head. A spindle motor drives rotation of the discs in disc pack 126 in a direction such as that shown by arrow 107. As discs are rotated, read/write assembly 112 accesses different rotational locations on the storage surfaces 106 in disc pack 126. Read/write assembly 112 is actuated for radial movement relative to the disc surfaces 106, such as in a direction indicated by arrow 122, in order to access different tracks (or radial positions) on the disc surfaces 106. Such actuation of read/write assembly 112 is illustratively provided by a servo system that includes a voice coil motor (VCM) 118. Voice coil motor 118 includes a rotor 116 that pivots on axis 120. VCM 118 also illustratively includes an arm 114 that supports the read/write head assembly 112.

Disc drive 100 illustratively includes control circuitry 130 for controlling operation of disc drive 100 and for transferring data in and out of the disc drive 100. Disc drive 100 also includes a single particle filter element 132.

FIG. 2 schematically illustrates an embodiment of a disc storage drive 150 that includes both a particle impact layer 152 and a recirculation filter element 184. The disc drive 150 comprises one or more discs 156 that have disc surfaces 158 that extends from a central hub 160 to an outer disc edge 162. The disc 156 spins about a central axis 164 as indicated by arrow 166.

A layer of air adjacent the disc surface 158 is subject to contamination by particles. The spinning of disc surface 158 induces a component of radial air flow, indicated by arrows 168. The radial airflow results from centrifugal force in spinning air adjacent the spinning disc 156. The spinning of disc surface 158 also induces a component of recirculation air flow indicated by a broken line 170. As disc surface 158 spins, the spinning induces a circumferential flow of air that is partially blocked by a read/write assembly 171 and arm 173. Blocking the circumferential air flow generates a pressure drop between an upstream side of the read/write assembly 171 and a downstream side of the read/write assembly 171. The pressure drop induces a recirculation air flow as indicated by broken line 170. Both the radial air flow 168 and the recirculation air flow 170 can carry undesired particles. The read/write assembly 171 blocks circumferential air flow. The particle impact layer 152 has a downstream end 153, and a filter 154 is positioned between the downstream end 153 and the read/write assembly 171.

A shroud 172 is spaced apart from the outer disc edge 162 and faces the radial air flow 168. The particle impact layer 152 is disposed on the shroud 172. The particle impact layer 152 is formed of a material that traps a first portion of the particles carried by the radial air flow 168. In a preferred arrangement, the particle impact layer 152 partially surrounds the disc 156 and extends around more than half of the circumference of the disc 156. The trapping of the first portion of particles inhibits recirculation of the first portion of particles back into the layer of air over the disc 156.

The filter 154 is disposed adjacent the outer disc edge 156. In a preferred arrangement, the filter 154 is placed with a filter inlet 180 adjacent the higher pressure, upstream side of the read/write assembly 171. A filter outlet 182 is positioned adjacent a region that is fluidly coupled to the lower, downstream pressure. This positioning of filter 154 provides a preferred high pressure drop between the filter inlet 180 and the filter outlet 182. The pressure drop between the filter inlet 180 and the filter outlet 182 induces recirculation air flow through the filter 154. The filter 154 comprises the recirculation filter element 184 that traps a second portion of the particles carried by the recirculation air flow 170. The trapping of the second portion of particles inhibits recirculation of the second portion of particles back into the layer of air over the disc 156.

In a preferred arrangement, the filter further comprises an air dam 186 that provides additional blocking of circumferential air flow and an increased pressure differential between the filter inlet 180 and the filter outlet 182. The filter 154 is positioned between the downstream end 153 and the air dam 186.

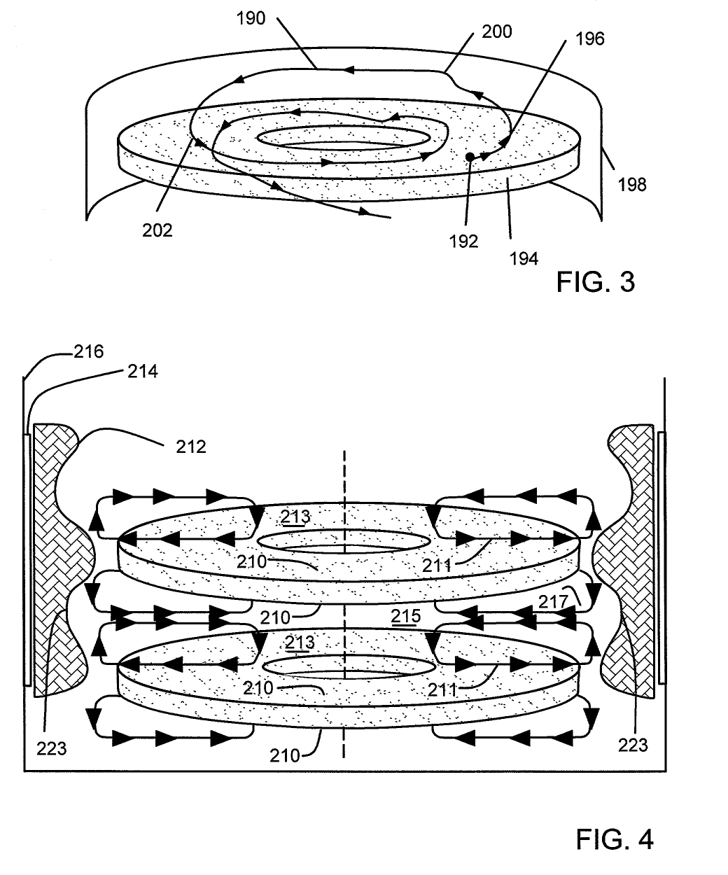

FIG. 3 schematically illustrates a path 190 of a particle 192 near a spinning disc 194. The particle 192 has both radial and circumferential components of motion, and moves outwardly along a generally spiral path 196 and impacts a bare shroud 198 at 200. The particle 192 is not trapped by the bare shroud 198 and moves back onto the spinning disc 194 at 202. As illustrated, particle 192 can recirculate back onto the disc 194 many times, where it is available to damage either the disc 194 or a read/write head (not illustrated) flying over the disc 194. Any particle in the air stream flowing near the disc surface will tend to flow outwardly until it sheds off the disc and impinges on the wall surrounding the discs. If the particle does not escape the shrouded disc area via the recirculation air flow, it will flow back toward the spindle and re-enter the head/disc interface region, increasing the chance of creating a defect if it comes between the head and disc.

FIG. 4 schematically illustrates a cross sectional view of layers of air adjacent disc surfaces 210. The layers of air include a radial component 211 of air flow that passes over the disc surfaces 210 and also passes over a particle impact layer 212, illustrated in cross-section. The particle impact layer 212 preferably comprises a microstructured filter membrane, and at least of a portion of the particle impact layer 212 is preferably electrostatically charged and has low-outgassing properties suitable for use in a disc drive. An adhesive material 214 can be used to attach the particle impact layer 212 to the shroud 216.

In a preferred arrangement, there are multiple discs 213 separated from one another by disc spacing regions 215 and the particle impact layer has a ribbed shape with valleys 223 facing the disc spacing regions 215.

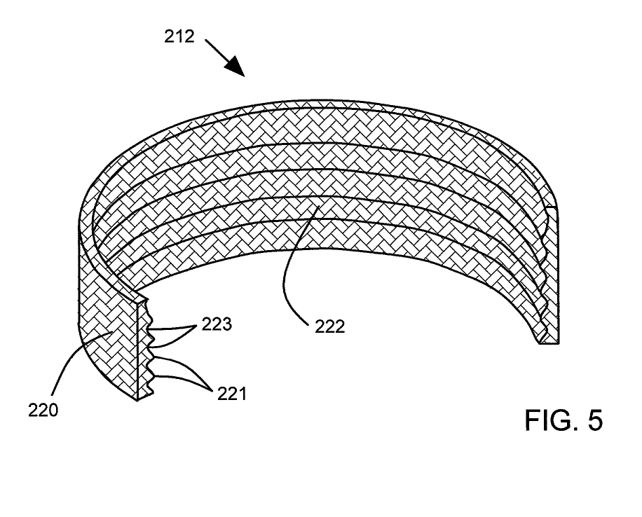

FIG. 5 schematically illustrates an oblique view of the particle impact layer 212 shown in FIG. 4. The particle impact layer 212 has an outer surface 220 that receives the adhesive 214. The particle impact layer 212 also has an inner surface 222 that is scalloped or ribbed to conform to spaces around the disc surfaces 210. The scalloped inner surface 222 also serves to provide mechanical damping and reduce disc resonance.

The ‘ribbed shape’ and ‘peak-to-valley’ pattern of the inner surface 222 runs the circumferential length of the particle impact layer 212. The ‘peaks’ or the ‘protruded parts’ 221 of the ribs point in the direction of the edge of the disk. Thus, the valleys 223 provide channels for the air to flow, in a laminar manner. The peak-to-valley pattern provides greater surface area for trapping particles than a flat circumferential surface. Mixed polypropylene (PP) and acrylic (A) fibrous material can be used in impact layer 212 for providing electrostatic attraction, which is desirable for attracting and trapping particles. The mixed polypropylene and acrylic fibrous material is preferably a non-woven material that is shaped in the ribbed shape, providing depth for trapping particles of all sizes. The mixed polypropylene and acrylic is an attractive material from the cost standpoint as well as the electrostatic consideration. Other materials that can be used include polyethylene (PE), polypentene (PPE), polyethylenimine, polyaniline, polybutylacrylate, preferably as a mixed fibrous shaped material.

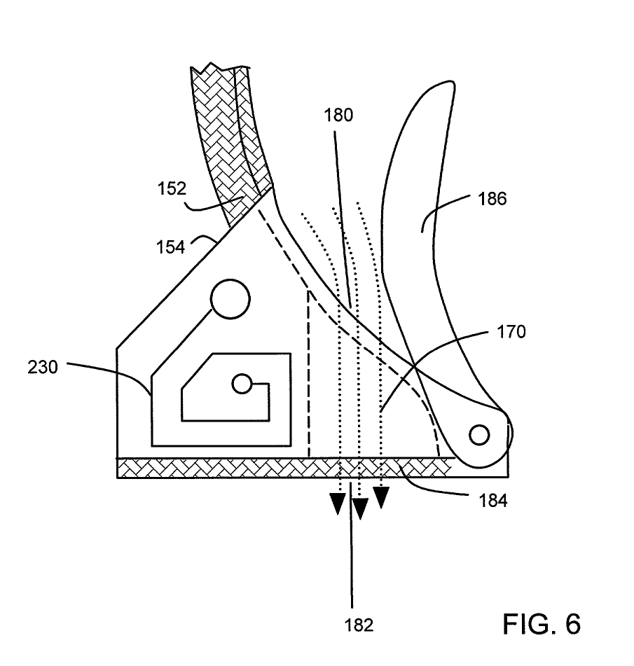

FIG. 6 schematically illustrates the filter 154 illustrated in FIG. 2 and the recirculation filter element 184. In a preferred arrangement, the filter 154 further comprises a chemical filter, a breather filter, and a diffusion filter 230. The recirculation filter element 184 filters a portion of the air before it re-enters the head/disc region. The placement of the filter with an inlet 180 adjacent a higher pressure region and an outlet 182 adjacent a lower pressure region is optimal for maximum particle removal from the recirculation air flow 170.

An accelerated defect stress test performed on sample drives shows drives that include both a particle impact layer 152 and a recirculation filter element 184 to be more impervious to defect growth. In one embodiment, tests show the impact layer 152 combined with a recirculation filter 184 improve the cleanup rate by 60% during the first 10 second and by 50% after 60 seconds. Additional tests show that addition of the impact layer reduces spindle motor power by 4% and attenuates disc resonance.

The particle impact layer-filter combination enhances filtration and, at the same time, reduces disc and suspension resonance by combining filtration functions into the unitary arrangement as shown in FIGS. 2-3.

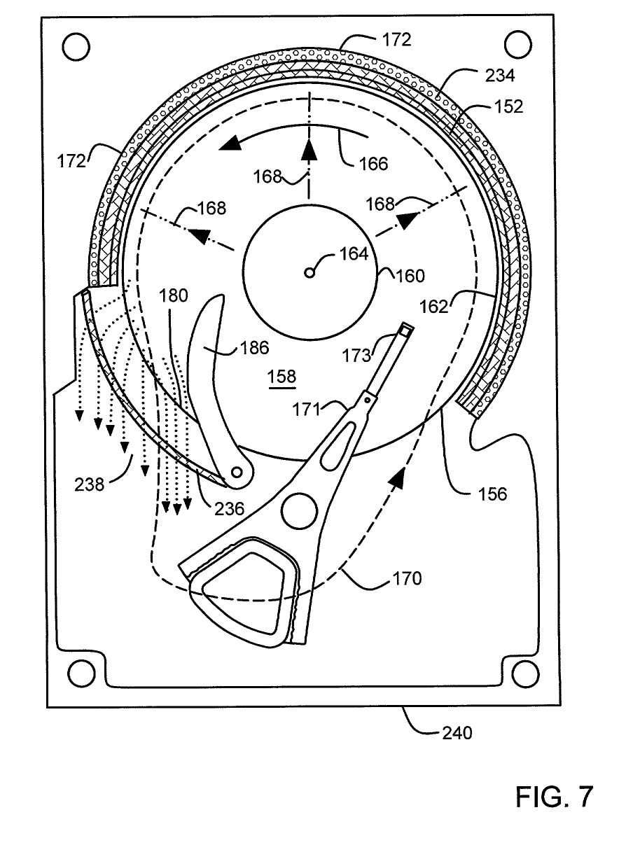

FIG. 7 schematically illustrates an alternate embodiment of a disc storage drive 240 that includes a chemical filter backing 234 interposed between a shroud 172 and a particle impact layer 152. The chemical filter backing is preferably a carbon composition. The disc storage drive 240 illustrated in FIG. 7 is similar to the disc storage drive 150 illustrated in FIG. 2 and references numbers used in FIG. 7 that are the same as reference numbers used in FIG. 2 identify similar features. In FIG. 7, a recirculation filter element 236 filters recirculation air flow 170. A filter inlet 180 is at a higher pressure than a filter outlet 238.

Particle injection experiments show that particles not captured in a recirculation filter tend to lodge in other areas of the drive enclosure. Thus, additional particle filtration can be attained if the recirculation filter is combined with a particle impact layer on the shroud. The particle impact layer on the shroud traps particles as they are shed off the discs, before they have a chance to re-enter the head/disc interface.

Alternatively described, a disc drive (150) includes a disc (156) having a disc surface (158) that extends from a central hub (160) to an outer disc edge (162). The disc (156) is spun about a central axis (164). A layer of air is adjacent the disc surface (158) and is subject to contamination by particles. The disc surface (158) induces a radial air flow (168) and a recirculation air flow (170).

A shroud (172) is spaced apart from the outer disc edge (162) and faces the radial air flow (168). A particle impact layer (152) is disposed on the shroud (172). The particle impact layer (152) is formed of a material that traps a first portion of the particles that is carried by the radial air flow (168).

A filter (154) is also disposed adjacent the outer disc edge (162). The filter (154) comprises a recirculation filter element (184) that traps a second portion of the particles that is carried by the recirculation air flow (170).

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the disc drive while maintaining substantially the same functionality without departing from the scope and spirit of the present invention. For example, the particle impact layers and filters may vary in size and shape and position relative to one another. In addition, although the preferred embodiment described herein is directed a magnetic hard disc drive, it will be appreciated by those skilled in the art that the arrangement is also adaptable to optical and magnetoptical drives. The teachings of the present invention can be applied to other magnetic systems, like tape drives, without departing from the scope of the present invention.

What is claimed is:

1. A disc drive, comprising:
a disc having a disc surface that extends from a central hub to an outer disc edge, the disc spinning about a central axis;
a layer of air adjacent the disc surface and subject to contamination by particles, the disc surface inducing a radial air flow and a recirculation air flow;
a shroud that is spaced apart from the outer disc edge and that faces the radial air flow;
a particle impact layer that is disposed on the shroud; the particle impact layer being formed of a material that traps a first portion of the particles carried by the radial air flow; and
a filter that is disposed adjacent the outer disc edge and that comprises a recirculation filter element that traps a second portion of the particles carried by the recirculation air flow.

2. The disc drive of claim 1 further comprising a read/write assembly blocking a circumferential air flow, and the particle impact layer has a downstream end, and the filter is positioned between the downstream end and the read/write assembly.

3. The disc drive of claim 1 wherein the filter further comprises an air dam.

4. The disc drive of claim 3 wherein the particle impact layer has a downstream end, and the filter is positioned between the downstream end and the air dam.

5. The disc drive of claim 1 wherein the disc drive comprises multiple discs separated from one another by a disc spacing regions and the particle impact layer has a ribbed shape with valleys facing toward the disc spacing regions.

6. The disc drive of claim 1 wherein the trapping of the first portion of particles inhibits recirculation of the first portion of particles back into the layer of air.

7. The disc drive of claim 1 wherein the particle impact layer comprises a microstructured filter membrane.

8. The disc drive of claim 1, wherein at least a portion of the particle impact layer is electrostatically charged.

9. The disc drive of claim 1, wherein the particle impact layer comprises a low-outgassing material.

10. The disc drive of claim 1, further comprising an adhesive material that attaches the particle impact layer to the shroud.

11. The disc drive of claim 1 wherein the filter further comprises a chemical filter.

12. The disc drive of claim 1 wherein the filter further comprises a breather filter.

13. The disc drive of claim 1 wherein the filter further comprises a diffusion filter.

14. The disc drive of claim 1 further comprising a chemical filter backing interposed between the shroud and the particle impact layer.

15. A method of removing particles of contamination from a layer of air adjacent a spinning disc in a disc drive, comprising:
providing a disc surface on the spinning disc that extends from a central hub to an outer disc edge, the spinning of the disc inducing a radial air flow and a recirculation air flow in the layer of air;
positioning a shroud to be spaced apart from the outer disc edge and to face the radial air flow;
providing a particle impact layer on the shroud that is formed of a material that traps a first portion of the particles carried by the radial air flow; and
providing a filter adjacent the outer disc edge that comprises a recirculation filter element trapping a second portion of the particles carried by the recirculation air flow.

16. The method of claim 15 wherein the filter further comprises an air dam.

17. The method of claim 15 wherein the particle impact layer comprises a microstructured polypropylene film.

18. The method of claim 17, wherein at least a portion of the particle impact layer is electrostatically charged.

19. A disc drive, comprising:
a disc surface on a spinning disc that extends from a central hub to an outer disc edge, the spinning of the disc inducing a radial air flow and a recirculation air flow in the layer of air, the layer of air being subject to contamination by particles; and a shroud spaced apart from the outer disc edge and facing the radial air flow; and
means for removing particles in the radial air flow and the recirculation air flow.

20. The disc drive of claim 19 wherein the means for removing particle includes a first means for removing particles from the radial air flow and a second means for removing particles from the recirculation air flow.

21. The disc drive of claim 19 wherein the means for removing particles further comprises a third means for generating a pressure drop across the second means for removing particles from the recirculation air flow.
